(19) United States
(12) Patent Application Publication
(10) Pub. No.: US 2026/0334554 A1
(43) Pub. Date: Oct. 29, 2026

(54) ATOMIZER AND AEROSOL GENERATING DEVICE

(71) Applicant: SHENZHEN SMOORE TECHNOLOGY LIMITED, Shenzhen (CN)

(72) Inventors: Jidong SU, Shenzhen (CN); Hu JIN, Shenzhen (CN); Chunming HUA, Shenzhen (CN); Fei PENG, Shenzhen (CN); Xiangshang MENG, Shenzhen (CN)

(73) Assignee: SHENZHEN SMOORE TECHNOLOGY LIMITED, Shenzhen (CN)

(21) Appl. No.: 19/658,358

(22) Filed: Apr. 24, 2026

(30) Foreign Application Priority Data
Apr. 25, 2025 (CN) 202520810515.1

(51) Int. Cl. A24F 40/46; A24F 40/10; A24F 40/30; A24F 40/42; A24F 40/485; A24F 40/50; H05B 3/80

(52) U.S. Cl. CPC A24F 40/46; A24F 40/10; A24F 40/30; A24F 40/42; A24F 40/485; A24F 40/50; H05B 3/80

(57) ABSTRACT

An atomizer includes: an atomization base having a first side and a second side that face away from each other; a liquid storage member connected to the atomization base, the liquid storage member having at least one liquid storage reservoir for storing an aerosol generating substrate, the at least one liquid storage reservoir being located on the first side; and a heating assembly disposed on the atomization base, the heating assembly including two heating elements for heating the aerosol generating substrate so as to generate aerosols, each heating element of the two heating elements including a heating surface. A heating surface of one heating element of the two heating elements is parallel to a direction from the first side to the second side. A heating surface of another heating element of the two heating elements is perpendicular to the direction from the first side to the second side.

### CROSS-REFERENCE TO PRIOR APPLICATION

Priority is claimed to Chinese Patent Application No. 202520810515.1, filed on Apr. 25, 2025, the entire disclosure of which is hereby incorporated by reference herein.

### FIELD

This application relates to the technical field of atomization, and more specifically, to an atomizer and an aerosol generating device.

### BACKGROUND

An aerosol generating device is an apparatus capable of heating an aerosol generating substrate in a heat-not-burn (HNB) manner to generate aerosols. Generally, the aerosol generating device includes an atomizer. The atomizer includes a heating element. The heating element is configured to heat the aerosol generating substrate to generate aerosols. However, the atomizer generally includes only one heating element. As a result, the aerosol generation amount is relatively small. It hardly meets usage needs of users.

### SUMMARY

In an embodiment, the present invention provides an atomizer, comprising: an atomization base comprising a first side and a second side that face away from each other; a liquid storage member connected to the atomization base, the liquid storage member having at least one liquid storage reservoir configured to store an aerosol generating substrate, the at least one liquid storage reservoir being located on the first side; and a heating assembly disposed on the atomization base, the heating assembly comprising two heating elements configured to heat the aerosol generating substrate so as to generate aerosols, each heating element of the two heating elements comprising a heating surface, wherein a heating surface of one heating element of the two heating elements is parallel to a direction from the first side to the second side, and wherein a heating surface of another heating element of the two heating elements is perpendicular to the direction from the first side to the second side.

### BRIEF DESCRIPTION OF THE DRAWINGS

To describe the technical solutions in the embodiments of this application more clearly, the following briefly introduces the accompanying drawings for describing the embodiments or the exemplary technology Apparently, the accompanying drawings in the following description show merely some embodiments of this application, and a person of ordinary skill in the art may still derive other drawings from the accompanying drawings without creative efforts.

FIG. 1 is a schematic diagram of a three-dimensional structure of an aerosol generating device according to some embodiments of this application;

FIG. 2 is a three-dimensional schematic exploded diagram of an atomizer in the aerosol generating device shown in FIG. 1;

FIG. 3 is a schematic cross-sectional diagram of one embodiment of an atomizer in the aerosol generating device shown in FIG. 1;

FIG. 4 is a schematic enlarged view of part IV in FIG. 3;

FIG. 5 is a schematic cross-sectional diagram of another embodiment of an atomizer in the aerosol generating device shown in FIG. 1;

FIG. 6 is a schematic enlarged view of part VI in FIG. 5;

FIG. 7 is a schematic diagram of a three-dimensional structure of one view of a partial structure in an atomizer according to some embodiments of this application; and

FIG. 8 is a schematic diagram of a three-dimensional structure of another view of a partial structure in an atomizer according to some embodiments of this application.

### DETAILED DESCRIPTION

In an embodiment, the present invention provides an atomizer and an aerosol generating device, to solve the at least one technical problem mentioned above.

The atomizer of this embodiment of this application includes an atomization base, a liquid storage member, and a heating assembly. The atomization base includes a first side and a second side that face away from each other. The liquid storage member is connected to the atomization base. The liquid storage member is provided with a liquid storage reservoir for storing an aerosol generating substrate. The liquid storage reservoir is located on the first side. The heating assembly is disposed on the atomization base and includes two heating elements. The two heating elements are configured to heat the aerosol generating substrate to generate aerosols and each of the two heating elements includes a heating surface. The heating surface of one of the two heating elements is parallel to a direction from the first side to the second side, and the heating surface of the other heating element is perpendicular to the direction from the first side to the second side.

In some embodiments, two liquid storage reservoirs are provided, which are spaced apart from each other. The two heating elements are respectively configured to heat the aerosol generating substrates in the two liquid storage reservoirs.

In some embodiments, the atomization base is provided with two atomization channels and a liquid guide channel. The atomization base is further provided with two air inlet holes. The two air inlet holes are respectively communicated with the two atomization channels and are configured to allow external air to flow into the corresponding atomization channels.

In some embodiments, two atomization channels and two liquid guide channels are provided. The two atomization channels include a first atomization channel and a second atomization channel. The two liquid guide channels comprise a first liquid guide channel and a second liquid guide channel. The two heating elements include a first heating element and a second heating element. The first heating element comprises a first heating surface. The first heating surface is parallel to the direction from the first side to the second side and is opposite to the first atomization channel. The first heating element is disposed at the first liquid guide channel. The second heating element comprises a second heating surface. The second heating surface is perpendicular to the direction from the first side to the second side and is opposite to the second atomization channel. The second heating element is disposed at the second liquid guide channel.

In some embodiments, the first heating element further includes a first liquid guide surface facing away from the first heating surface. An abutting surface is formed on the inner wall of the first liquid guide channel. The abutting surface abuts against the first liquid guide surface. A first sealing element is disposed between the abutting surface and the first liquid guide surface. The first sealing element is configured to seal a gap between the abutting surface and the first liquid guide surface.

In some embodiments, the second heating element further includes a second liquid guide surface and a peripheral side surface. The second liquid guide surface faces away from the second heating surface. The peripheral side surface is connected between the second heating surface and the second liquid guide surface. A second sealing element is disposed between the peripheral side surface and the inner wall of the second liquid guide channel. The second sealing element is configured to seal a gap between the peripheral side surface and the inner wall of the second liquid guide channel.

In some embodiments, the atomization base includes a base, a first liquid guide member, and a second liquid guide member. The base is connected to the liquid storage member. The first liquid guide member is disposed on the side of the base facing the liquid storage reservoir and is provided with the first liquid guide channel. The second liquid guide member is disposed on the side of the base facing the liquid storage reservoir and is provided with the second liquid guide channel and a first sub-channel. The second liquid guide member forms the first atomization channel together with the first liquid guide member and forms a second sub-channel together with the base. The first sub-channel and the second sub-channel are communicated with each other to jointly form the second atomization channel.

In some embodiments, the second liquid guide member includes a first sub-member and a second sub-member. The first sub-member is arranged on the base. The first sub-member is provided with a first sub-path and a part of the first sub-channel, and forms the second sub-channel together with the base. The second sub-member is connected to the side of the first sub-member facing away from the base. The second sub-member is provided with a second sub-path and another part of the first sub-channel. The first sub-path and the second sub-path are communicated with each other to jointly form the second liquid guide channel.

In some embodiments, a third sealing element is disposed between the first sub-member and the second sub-member. The third sealing element is configured to seal a gap between the first sub-member and the second sub-member.

The aerosol generating device of this embodiment of this application includes an electrical control assembly and the atomizer of any one of the foregoing embodiments. The atomizer is electrically connected to the electrical control assembly.

In the atomizer and the aerosol generating device in this embodiment of this application, the atomizer includes the heating assembly. The heating assembly includes the two heating elements. The heating elements are configured to heat the aerosol generating substrate to generate aerosols. Therefore, compared with only one heating element in the atomizer, more aerosols can be generated, thus helping enhance the inhalation mouth feel of a user and effectively meeting a usage need of the user.

The additional aspects and advantages of this application will be partially provided in the following descriptions, some of which will become apparent from the following descriptions, or learned through the practice of this application.

In the descriptions of this application, it should be understood that orientations or positional relationships indicated by "center", "longitudinal", "transverse", "length", "width", "thickness", "upper", "lower", "front", "rear", "left", "right", "vertical", "horizontal", "top", "bottom", "inner", "outer", "clockwise", "anticlockwise", "axial", "radial", "circumferential" and the like are orientations or positional relationships as shown in the drawings, and are only for the purpose of facilitating and simplifying the descriptions of this application instead of indicating or implying that devices or elements indicated must have particular orientations, and be constructed and operated in the particular orientations, so that these terms are not construed as limiting this application.

In addition, the terms "first" and "second" are used for descriptive purposes only and are not to be construed as indicating or implying relative importance or to implicitly indicate the number of technical features indicated. From this, features defined as "first" and "second" may explicitly or implicitly include at least one feature. In the description of this application, "a plurality of" means at least two, such as two and three unless it is specifically defined otherwise.

In this application, unless otherwise expressly specified and limited, the terms "mount", "connect", "connection", "fix", and the like should be understood in a broad sense, such as, a fixed connection, a detachable connection, an integrated connection, a mechanical connection, an electrical connection, a direct connection, an indirect connection through an intermediate medium, an internal communication of two elements, or interaction between two elements, unless expressly specified otherwise. Those of ordinary skill in the art can understand the specific meanings of the above terms in this application according to specific situations.

In this application, unless otherwise explicitly stipulated and restricted, that a first feature is "on" or "below" a second feature may include that the first and second features are in direct contact, or may include that the first and second features are in indirect contact using an intermediate. In addition, that the first feature is "on", "above", or "over" the second feature may include that the first feature is directly or diagonally above the second feature or merely indicates that a level of the first feature is higher than that of the second feature. The first feature "below", "beneath", and "under" of the second feature can indicate that the first feature is directly or diagonally below the second feature, or merely indicates that a level of the first feature is less than that of the second feature.

It should be noted that when an element is referred to as being "fixed to" or "arranged to" another element, the element can be directly on another component or there can be a centered element. When an element is considered to be "connected" to another element, the element can be directly connected to another element or there may be a centered element. The terms "vertical", "horizontal", "up", "down", "left", "right", and similar expressions used herein are for illustrative purposes only and do not necessarily represent the only embodiment.

Descriptions of reference numerals of main elements:

1000: aerosol generating device;

100: atomizer; 300: electrical control assembly;

10: atomization base; 11: first side; 12: second side; 13: atomization channel; 131: first atomization channel; 133:; second atomization channel; 1331: first sub-channel; 1333: second sub-channel; 14: liquid guide channel; 141: first liquid guide channel; 143: second liquid guide channel; 1431: first sub-path; 1433: second sub-path; 15: air inlet hole; 16: base; 17: first liquid guide member; 171: first ventilation channel; 18: second liquid guide member; 181: first sub-member; 183: second sub-member; 185: second ventilation channel; 19: top cover; 191: first via hole; 193: second via hole;

30: liquid storage member; 31: liquid storage reservoir; 33: air flow channel;

50: heating assembly; 501: heating element; 503: heating surface; 51: first heating element; 511: first heating surface; 513: first liquid guide surface; 53: second heating element; 531: second heating surface; 533: second liquid guide surface; 535: peripheral side surface;

61: first sealing element; 63: second sealing element; 65: third sealing element; 67: fourth sealing element; 69: fifth sealing element; 70: barrier; and 71: through hole.

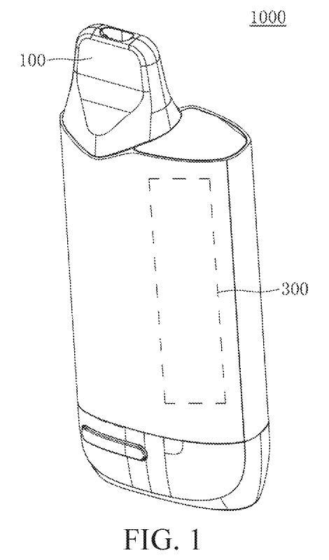

An aerosol generating device is an apparatus capable of heating an aerosol generating substrate in a heat-not-burn (HNB) manner to generate aerosols. Generally, the aerosol generating device includes an atomizer. The atomizer includes a heating element. The heating element is configured to heat the aerosol generating substrate to generate aerosols. However, the atomizer generally includes only one heating element. As a result, the aerosol generation amount is relatively small. It hardly meets usage needs of users. To solve the foregoing problems, referring to FIG. 1, an embodiment of this application provides an atomizer 100 and an aerosol generating device 1000.

Referring to FIG. 1, the aerosol generating device 1000 of this embodiment of this application includes an atomizer 100 and an electrical control assembly 300. The atomizer 100 is electrically connected to the electrical control assembly 300.

It can be understood that the atomizer 100 is a structure, capable of heating an aerosol generating substrate to generate aerosols, within the aerosol generating device 1000. The aerosol generating substrate is a product that can generate, after being treated, aerosols under the action of heating and ultrasonic or mechanical oscillation. The state of the aerosol generating substrate can be liquid, fully solid, or semi-solid. The aerosols may be visible or invisible and may include vapor (such as gaseous fine particulate matters, typically liquid or solid at the room temperature) and liquid droplets of air and condensed vapor.

The electrical control assembly 300 is a structure, configured to control the operation of the atomizer 100, in the aerosol generating device 1000. In some embodiments of this application, the electrical control assembly 300 includes a power source and a controller. The power source is configured to supply power to the atomizer 100.

The controller is electrically connected to the power source and is configured to adjust the voltage of the electrical energy. For example, when the aerosol generating device 1000 is inhaled, the controller can control the power source to output electrical energy to the atomizer 100 and adjust the voltage of the electrical energy outputted by the power source, to cause the adjusted voltage to adapt to the atomizer 100. In this case, the atomizer 100 can heat and atomize the aerosol generating substrate, so that the aerosol generating substrate generates aerosols. In a case that the aerosol generating device 1000 is not inhaled, the controller can stop the power source from supplying electrical energy to the atomizer 100. In this case, the atomizer 100 will not heat the aerosol generating substrate. It should be noted that in some embodiments, the power source can be a dry battery or rechargeable battery. The rechargeable battery includes but is not limited to a lithium-ion battery, a nickel-metal hydride battery, and a nickel-cadmium battery.

Further, in some embodiments, the aerosol generating device 1000 further includes a housing. The atomizer 100 and the electrical control assembly 300 are both disposed within the housing. Specifically, the housing is a structure, capable of accommodating and protecting devices such as the atomizer 100, within the aerosol generating device 1000. A material of the housing includes but is not limited to plastic, aluminum alloy, copper, iron, steel, and a carbon fiber composite material. In one example, the housing can be made of plastic, so that the housing is lighter, and it is conductive to achieving the lightweight of the aerosol generating device 1000. In another example, the housing may be made of a high-temperature-resistant material to prevent damage (such as deformation) caused by heat impact, thus ensuring the operation stability and reliability of the aerosol generating device 1000. The high-temperature-resistant material includes but is not limited to polyetheretherketone (PEEK), a high-melting-point metal, and high-temperature-resistant ceramic.

Since the aerosol generating device 1000 in this embodiment includes the atomizer 100. It can be understood that the aerosol generating device 1000 at least includes the same beneficial effects as the atomizer 100. Therefore, for the beneficial effects of the aerosol generating device 1000, refer to the beneficial effects of the atomizer 100 described below.

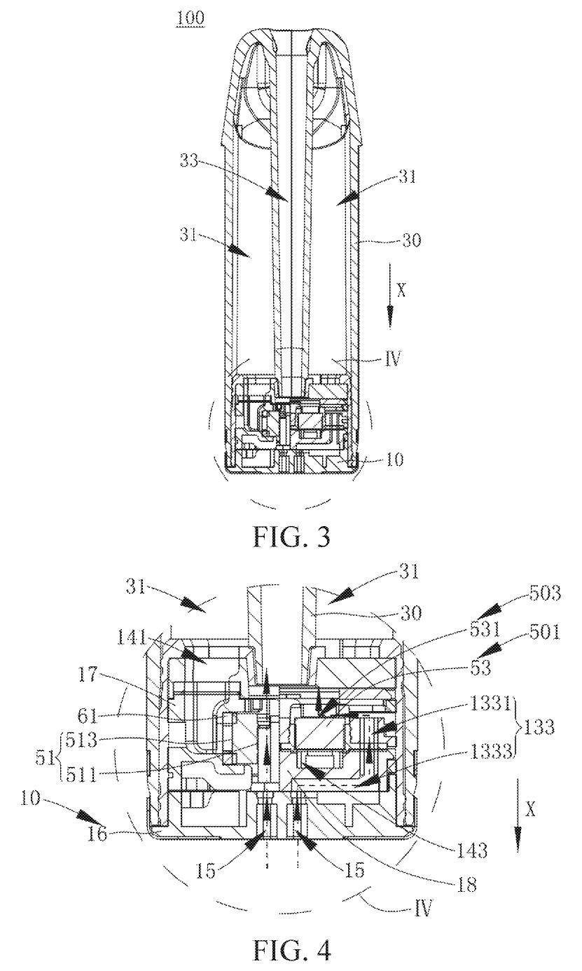

Referring to FIGS. 1-4, the atomizer 100 of this embodiment of this application includes an atomization base 10, a liquid storage member 30, and a heating assembly 50. The atomization base 10 includes a first side 11 and a second side 12 that face away from each other. The liquid storage member 30 is connected to the atomization base 10. The liquid storage member 30 is provided with a liquid storage reservoir 31 for storing an aerosol generating substrate. The liquid storage reservoir 31 is located on the first side 11. The heating assembly 50 is disposed on the atomization base 10 and includes two heating elements 501. The two heating elements 501 are configured to heat the aerosol generating substrate to generate aerosols and each of the two heating elements 501 includes a heating surface 503. The heating surface 503 of one of the two heating elements 501 is parallel to a direction from the first side 11 to the second side 12, and the heating surface 503 of the other heating element 501 is perpendicular to the direction from the first side 11 to the second side 12. It should be noted that in some embodiments, the heating surface 503 of the other heating element 501 is not only perpendicular to the direction from the first side 11 to the second side 12, but also faces the first side 11.

It can be understood that the atomization base 10 is a structure, configured to load an element except the atomization base 10, within the atomizer 100.

The element except the atomization base 10 herein includes but is not limited to the heating element 501. The outer contour shape of the atomization base 10 may include but is not limited to a cylinder, a cube, a rectangular solid, a triangular prism, a hexagonal prism, and the like. A material of the atomization base 10 includes but is not limited to plastic, glass, ceramic, metal, and the like.

The liquid storage member 30 is a structure, configured to store the aerosol generating substrate, within the atomizer 100. A material of the liquid storage member 30 includes but is not limited to polyester (PET), polypropylene (PP), acrylonitrile butadiene styrene (ABS) plastic, aluminum alloy, glass, or the like. The shape of the liquid storage reservoir 31 may be in a regular shape such as a cylindrical shape or a conical shape, or an irregular shape. In this embodiment of this application, the liquid storage member 30 is further provided with an air flow channel 33. The air flow channel 33 is configured to allow the aerosols to flow out of the atomizer 100. That is, a user can inhale the aerosols in the atomizer 100 through the air flow channel 33. In addition, the liquid storage reservoir 31 is located on the first side 11. In this way, the aerosol generating substrate in the liquid storage reservoir 31 can flow into the atomization base 10 from the first side 11.

The heating assembly 50 is a structure, configured to heat the aerosol generating substrate, within the atomizer 100. In some embodiments of this application, the heating assembly 50 includes two heating elements 501. The heating elements 501 are devices or materials that can generate thermal energy and transfer the thermal energy to a surrounding environment. Certainly, in other embodiments, the heating assembly 50 may further include at least three heating elements 501. For ease of understanding, the following embodiment uses an example in which the heating assembly 50 includes two heating elements 501.

For example, each heating element 501 may include porous ceramic, a heating layer, and a conductive component. The heating layer is located on one side of the porous ceramic and is disposed on the heating surface 503 of the heating element 501. The conductive component is electrically connected to the heating layer. Therefore, in a case that the power source supplies power to the conductive component, the heating layer can heat and atomize the aerosol generating substrate in the porous ceramic on the heating surface 503 to generate aerosols. It should be noted that in some embodiments, the porous ceramic is generally prepared by mixing ceramic slurry with a pore forming agent and then sintering the mixture, and a sintered ceramic body has a large number of micropores (not shown in the figure). The heating layer includes but is not limited to a heating circuit, a heating layer, a heating sheet, a heating wire, a heating mesh, and the like. The conductive component includes but is not limited to an electrode. The electrode can be sheet-like, columnar, powdered, or porous. This is not limited herein.

If the heating surface 503 of the heating element 501 faces the second side 12. That is, when the aerosol generating device 1000 is used, the heating surface 503 of the heating element 501 faces downwards, the aerosols generated at the heating surface 503 needs to upwards bypass the porous ceramic before they can be inhaled by a user. A flow path of the aerosols is more complex. As a result, aerosols with the large particle size will be lost in the flowing process of the aerosols. This affects the inhalation mouth feel. In addition, the complex flow path of the aerosols can also lead to a decrease in the temperature of the aerosols. In addition, since the characteristic aroma (such as melon and fruit fragrance) of the aerosols is easily affected by the temperature of the aerosols, the temperature of the aerosols can also decrease, which will also affect the inhalation mouth feel.

In some embodiments of this application, the heating surface 503 of one heating element 501 is parallel to the direction from the first side 11 to the second side 12, and the heating surface 503 of the other heating element 501 faces the first side 11 and is perpendicular to the direction from the first side 11 to the second side 12. That is, one heating element 501 can perform lateral atomization, and the other heating element 501 can perform upward atomization. Therefore, generated aerosols can be inhaled by a user without bypassing the porous ceramic, and the flow path of the aerosols is simpler, so that the loss of the aerosols with the large particle size can be mitigated, and the decrease in the temperature of the aerosols can be prevented, thereby enhancing the inhalation mouth feel of the user. It should be noted that in some embodiments, the direction from the first side 11 to the second side 12 is parallel to the centerline of the air flow channel 33.

In the atomizer 100 in this embodiment of this application, the atomizer 100 includes the heating assembly 50. The heating assembly 50 includes the two heating elements 501. The heating elements 501 are configured to heat the aerosol generating substrate to generate aerosols. Therefore, compared with only one heating element 501 in the atomizer 100, more aerosols can be generated, thus helping enhance the inhalation mouth feel of a user and effectively meeting a usage need of the user.

In addition, the heating assembly 50 includes two heating elements 501. Therefore, in a case that the atomizer 100 is in operation, at least one of the two heating elements 501 can be energized to generate heat to heat the aerosol generating substrate. That is, the two heating elements 501 can work independently, alternately, or in a combination manner to heat the aerosol generating substrate, thereby increasing the number of gears of the atomizer 100 and effectively meeting the usage need of the user.

The following will further describe the atomizer 100 in conjunction with the accompanying drawings.

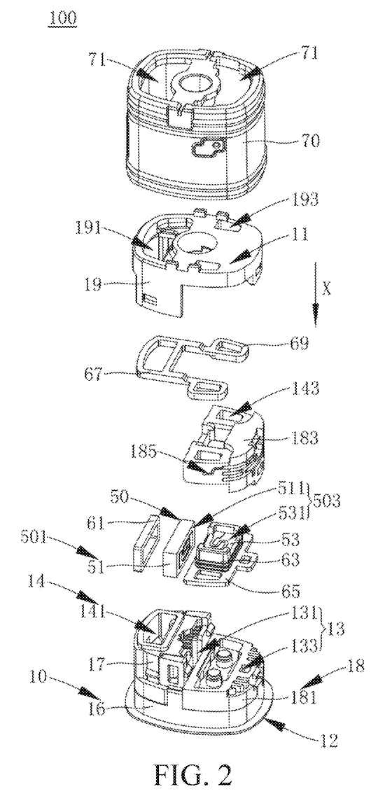

Referring to FIGS. 2-4, in some embodiments, two liquid storage reservoirs 31 are provided, which are spaced apart from each other. The two heating elements 501 are respectively configured to heat the aerosol generating substrates in the two liquid storage reservoirs 31.

Specifically, in some embodiments, the liquid storage member 30 may be provided with an accommodating cavity and a through hole communicated with the accommodating cavity. The accommodating cavity is configured to store the aerosol generating substrate, and the through hole is configured to allow the aerosol generating substrate in the accommodating cavity to flow out of the accommodating cavity. A partition plate is disposed within the accommodating cavity. The partition plate is configured to divide the accommodating cavity into the two liquid storage reservoirs 31 that are not communicated, and divide the through hole into two openings. The two openings are respectively communicated with the two liquid storage reservoirs 31. In other words, the liquid storage member 30 is further provided with an opening communicated with the liquid storage reservoirs 31. The opening is configured to allow the aerosol generating substrate in the corresponding liquid storage reservoirs 31 to flow out to the outsides of the liquid storage reservoirs 31.

More specifically, in some embodiments, the flavors of the aerosol generating substrates stored in the two liquid storage reservoirs 31 may be the same. In this case, when the two heating elements 501 respectively heat the aerosol generating substrates in the two liquid storage reservoirs 31, compared with the atomizer 100 that includes only one heating element 501, more aerosols will be generated. This is conducive to enhancing the inhalation mouth feel of a user and effectively meeting a usage need of the user.

In some other embodiments, the flavors of the aerosol generating substrates stored in the two liquid storage reservoirs 31 may be different. In this case, when the two heating elements 501 respectively heat the aerosol generating substrates in the two liquid storage reservoirs 31, the flavors of generated aerosols can be mixed, thereby enhancing the richness of the flavor, effectively satisfying inhalation mouth feel and usage needs of a user and enhancing the competitiveness of the product.

Referring to FIGS. 2 and 4, in some embodiments, the atomization base 10 is provided with an atomization channel 13 and a liquid guide channel 14.

Specifically, in some embodiments, the heating surfaces 503 are opposite to the atomization channel 13, and the heating elements 501 are at least partially disposed within the liquid guide channel 14. The liquid guide channel 14 is configured to allow the aerosol generating substrates in the liquid storage reservoirs 31 to flow towards the heating elements 501. When the aerosol generating device 1000 (shown in FIG. 1) is inhaled, the aerosol generating substrates in the liquid storage reservoirs 31 can flow towards the heating elements 501 through the liquid guide channel 14. In this case, the heating elements 501 can heat and atomize the aerosol generating substrates and generate aerosols in the atomization channel 13.

Further, referring to FIG. 4, in some embodiments, two atomization channels 13 are provided. The atomization base 10 is further provided with two air inlet holes 15. The two air inlet holes 15 are respectively communicated with the two atomization channels 13 and configured to allow external air to flow into the corresponding atomization channels 13. The cross-sectional dimensions of the two air inlet holes 15 are the same. Thus, the amounts of the external air flowing into the two atomization channels 13 are the same, so that the amount of aerosols generated by the aerosol generating substrates heated by the two heating elements 501 are roughly the same, thereby ensuring the uniformity of aerosol mixing and enhancing the inhalation mouth feel of a user.

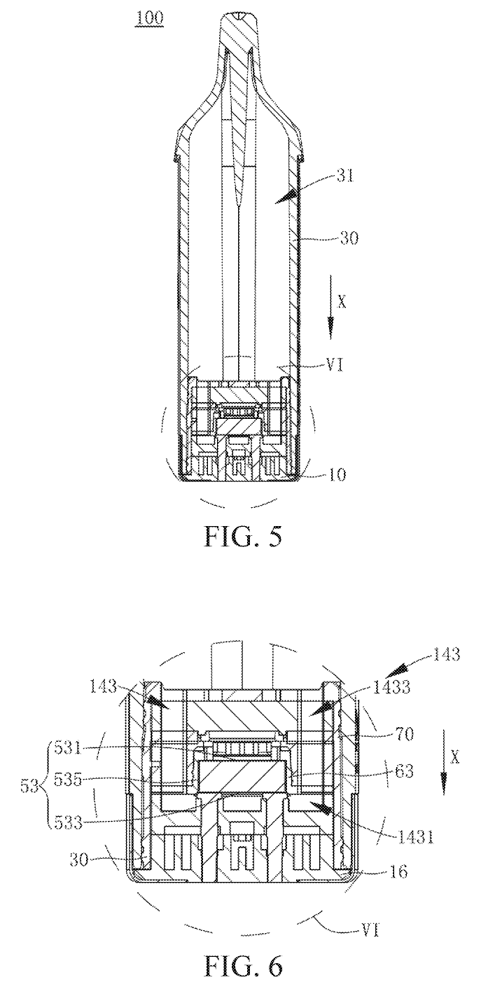

Referring to FIGS. 2, 4, 5, and 6, in some embodiments, two atomization channels 13 and two liquid guide channels 14 are provided. The two atomization channels 13 include a first atomization channel 131 and a second atomization channel 133. The two liquid guide channels 14 include a first liquid guide channel 141 and a second liquid guide channel 143. The two heating elements 501 include a first heating element 51 and a second heating element 53. The first heating element 51 includes a first heating surface 511. The first heating surface 511 is parallel to the direction from the first side 11 to the second side 12 and is opposite to the first atomization channel 131. The first heating element is disposed on the first liquid guide channel 141.

The second heating element 53 includes a second heating surface 531. The second heating surface 531 is perpendicular to the direction from the first side 11 to the second side 12 and is opposite to the second atomization channel 133. The second heating element is disposed at the second liquid guide channel 143.

Specifically, in some embodiments, the first heating element 51 is at least partially disposed within the first liquid guide channel 141, and the first liquid guide channel 141 is configured to allow the aerosol generating substrate in the liquid storage reservoir 31 to flow towards the first heating element 51, so that the first heating element 51 can heat and atomize the aerosol generating substrate to generate aerosols in the first atomization channel 131. The second heating element 53 is at least partially disposed within the second liquid guide channel 143, and the second liquid guide channel 143 is configured to allow the aerosol generating substrate in the other liquid storage reservoir 31 to flow towards the second heating element 53, so that the second heating element 53 can heat and atomize the aerosol generating substrate to generate aerosols in the second atomization channel 133. It should be noted that the air flow channel 33 is communicated with both the first atomization channel 131 and the second atomization channel 133. In this way, the aerosols in the first atomization channel 131 and the second atomization channel 133 can be inhaled by a user through the air flow channel 33.

Referring to FIG. 4, in some embodiments, the first heating element 51 further includes a first liquid guide surface 513 facing away from the first heating surface 511. An abutting surface is formed on the inner wall of the first liquid guide channel 141. The abutting surface abuts against the first liquid guide surface 513.

In one aspect, the arrangement of the abutting surface can facilitate the mounting and positioning of the first heating element 51 in the first liquid guide channel 141, thereby enhancing the assembling efficiency of the first heating element 51. In another aspect, this can enlarge an abutting area between the first heating element 51 and the inner wall of the first liquid guide channel 141. That is, in addition to that the peripheral wall of the first heating element 51 (connected between the first heating surface 511 and the first liquid guide surface 513) can abut against the inner wall of the first liquid guide channel 141 (the side wall of the first liquid guide channel 141), the first liquid guide surface 513 can also abut against the inner wall (the abutting surface) of the first liquid guide channel 141, thereby enhancing the sealing property between the first heating element 51 and the inner wall of the first liquid guide channel 141.

Further, in some embodiments, a first sealing element 61 is disposed between the abutting surface and the first liquid guide surface 513. The first sealing element 61 is configured to seal a gap between the abutting surface and the first liquid guide surface 513. The arrangement of the first sealing element 61 can further enhance the sealing property between the first heating element 51 and the inner wall of the first liquid guide channel 141, and prevent the aerosol generating substrate from leaking into the first atomization channel 131 through the gap between the first heating element 51 and the inner wall of the first liquid guide channel 141. Thus, in one aspect, this can reduce the waste of the aerosol generating substrate. In another aspect, this can prevent the aerosol generating substrate from entering the first atomization channel 131 and blocking the air inlet hole 15 communicated with the first atomization channel 131, thereby enhancing the stability and reliability of operation of the aerosol generating device 1000. It should be noted that in some embodiments, the first sealing element 61 may be made of a material such as rubber, silicone, plastic, or synthetic fibers. The rubber material includes but is not limited to natural rubber, nitrile rubber, fluororubber, polyurethane rubber, ethylene-propylene-diene monomer, silicone rubber, or the like.

Referring to FIG. 6, in some embodiments, the second heating element 53 further includes a second liquid guide surface 533 and a peripheral side surface 535. The second liquid guide surface 533 faces away from the second heating surface 531. The peripheral side surface 535 is connected between the second heating surface 531 and the second liquid guide surface 533. A second sealing element 63 is disposed between the peripheral side surface 535 and the inner wall of the second liquid guide channel 143. The second sealing element 63 is configured to seal a gap between the peripheral side surface 535 and the inner wall of the second liquid guide channel 143.

The arrangement of the second sealing element 63 can enhance the sealing property between the second heating element 53 and the inner wall of the second liquid guide channel 143, and prevent the aerosol generating substrate from leaking into the second atomization channel 133 through the gap between the second heating element 53 and the inner wall of the second liquid guide channel 143. Thus, in one aspect, this can reduce the waste of the aerosol generating substrate. In another aspect, this can prevent the aerosol generating substrate from entering the second atomization channel 133 and blocking the air inlet hole 15 communicated with the second atomization channel 133, thereby enhancing the stability and reliability of operation of the aerosol generating device 1000. It should be noted that in some embodiments, the second sealing element 63 may be made of a material such as rubber, silicone, plastic, or synthetic fibers. The rubber material includes but is not limited to natural rubber, nitrile rubber, fluororubber, polyurethane rubber, ethylene-propylene-diene monomer, silicone rubber, or the like.

Referring to FIGS. 2-4, in some embodiments, the atomization base 10 includes a base 16, a first liquid guide member 17, and a second liquid guide member 18. The base 16 is connected to the liquid storage member 30. The first liquid guide member 17 is disposed on the side of the base 16 facing the liquid storage reservoir 31 and is provided with the first liquid guide channel 141. The second liquid guide member 18 is disposed on the side of the base 16 facing the liquid storage reservoir 31 and is provided with the second liquid guide channel 143 and a first sub-channel 1331. The second liquid guide member 18 forms the first atomization channel 131 together with the first liquid guide member 17 and forms a second sub-channel 1333 together with the base 16. The first sub-channel 1331 and the second sub-channel 1333 are communicated with each other to jointly form the second atomization channel 133.

Specifically, in some embodiments, the first atomization channel 131 includes a gap between the first liquid guide member 17 and the second liquid guide member 18, and one end of the first atomization channel 131 is communicated with the air inlet hole 15 (the air inlet hole 15 on the left hand side in FIG. 4), and the other end is communicated with the air flow channel 33. When the aerosol generating device 1000 is inhaled, external air flows into the first atomization channel 131 through the air inlet hole 15, so that when the first heating element 51 heats the aerosol generating substrate, aerosols can be generated, and the aerosols generated in the first atomization channel 131 can be inhaled by a user through the air flow channel 33 (as shown by the dashed arrow on the left hand side in FIG. 4). A groove is formed in the side of the second liquid guide member 18 facing the base 16, and/or a groove is formed in the side of the base 16 facing the second liquid guide member 18. The groove is the second sub-channel 1333. One end of the first sub-channel 1331 is communicated with the air flow channel 33. The other end of the first sub-channel 1331 is communicated with one end of the second sub-channel 1333. The other end of the second sub-channel 1333 is communicated with the air inlet hole 15 (the air inlet hole 15 on the right hand side in FIG. 4). Therefore, in a case that the aerosol generating device 1000 is inhaled, external air can flow into the second sub-channel 1333 through the air inlet hole 15 and into the first sub-channel 1331 through the second sub-channel 1333, so that when the second heating element 53 heats the aerosol generating substrate, aerosols can be generated. Furthermore, the aerosols generated in the second atomization channel 133 can be inhaled by a user through the air flow channel 33 (as shown by the dashed arrow on the right hand side in FIG. 4). It should be noted that in some embodiments, the second atomization channel 133 may roughly have a semi-closed square-in-square structure, and the second heating surface 531 is opposite to the first sub-channel 1331.

Further, referring to FIGS. 2, 4, and 6, in some embodiments, the second liquid guide member 18 includes a first sub-member 181 and a second sub-member 183. The first sub-member 181 is disposed on the base 16, and the first sub-member 181 is provided with a first sub-path 1431 and a part of the first sub-channel 1331 and forms the second sub-channel 1333 together with the base 16. The second sub-member 183 is connected to the side of the first sub-member 181 facing away from the base 16. The second sub-member 183 is provided with a second sub-path 1433 and another part of the first sub-channel 1331. The first sub-path 1431 and the second sub-path 1433 are communicated with each other to jointly form the second liquid guide channel 143.

Specifically, in some embodiments, the first sub-member 181 includes a first side wall and a second side wall that face away from each other. The first side wall is opposite to the base 16. The second sub-channel 1333 may be a groove formed in the first side wall, and the first sub-path 1431 may be a groove formed in the second side wall. In a case that the second heating element 53 is disposed within the second liquid guide member 18, the second liquid guide surface 533 is opposite to the first sub-path 1431.

In some embodiments, the first sub-member 181 and the second sub-member 183 are of integrated structures. That is, the first sub-member 181 and the second sub-member 183 are of an integrated structure made by integrated molding. This can enhance the structural strength of the second liquid guide member 18, prevent separation of the first sub-member 181 from the second sub-member 183 during the use of the aerosol generating device 1000, and then enhance the stability and reliability of operation of the aerosol generating device 1000. In some other embodiments, the first sub-member 181 and the second sub-member 183 are of separate structures. That is, the first sub-member 181 and the second sub-member 183 are two different structures. The first sub-member 181 and the second sub-member 183 can be combined together by using a detachable connection manner or a non-detachable connection manner. The detachable connection manner includes but is not limited to snap-in connection and bolt connection. The non-detachable connection manner includes but is not limited to bonding, welding, or the like.

Referring to FIGS. 2 and 6, in some embodiments, a third sealing element 65 is disposed between the first sub-member 181 and the second sub-member 183. The third sealing element 65 is configured to seal a gap between the first sub-member 181 and the second sub-member 183. Thus, in one aspect, this can prevent leakage from the second liquid guide channel 143 through the gap between the first sub-member 181 and the second sub-member 183, thereby reducing the waste of the aerosol generating substrate. In another aspect, this can prevent leakage from the second atomization channel 133 through the gap between the first sub-member 181 and the second sub-member 183, thereby preventing the aerosols in the second atomization channel 133 from leaking and ensuring the inhalation mouth feel of a user. It should be noted that in some embodiments, the third sealing element 65 may be made of a material such as rubber, silicone, plastic, or synthetic fibers. The rubber material includes but is not limited to natural rubber, nitrile rubber, fluororubber, polyurethane rubber, ethylene-propylene-diene monomer, silicone rubber, or the like.

In some embodiments of this application, the third sealing element 65 and the second sealing element 63 are of integrated structures. That is, the third sealing element 65 and the second sealing element 63 are of an integrated structure made by integrated molding. Thus, this can reduce the number of components of the atomizer 100, facilitate the mounting of the third sealing element 65 and the second sealing element 63, and help enhance the assembling efficiency of the atomizer 100.

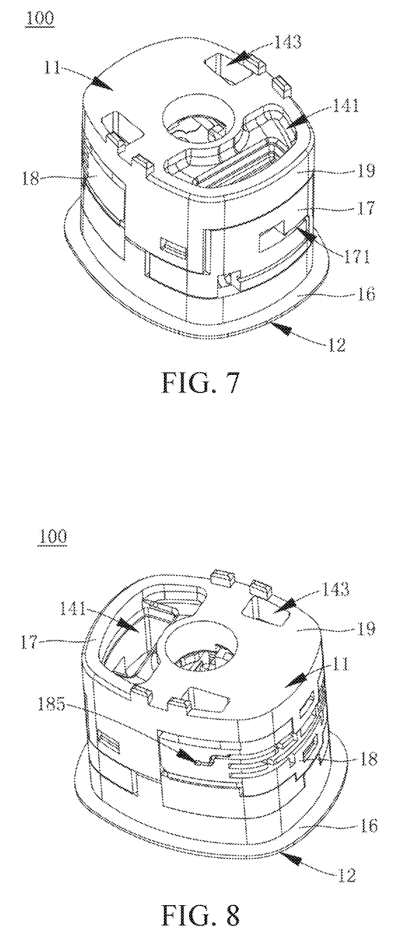

Referring to FIGS. 2, 3, 4, and 7, in some embodiments, the first liquid guide member 17 is provided with a first ventilation channel 171. The first ventilation channel 171 is communicated with both the external air and the first liquid guide channel 141, to allow the external air to flow into the liquid storage reservoir 31 through the first liquid guide channel 141. Specifically, in some embodiments, the first ventilation channel 171 may be disposed on the outer side of the peripheral wall of the first liquid guide member 17. Furthermore, one end of the first ventilation channel 171 is communicated with the air inlet hole 15 (the air inlet hole 15 communicated with the first atomization channel 131), and the other end of the first ventilation channel 171 is communicated with the first liquid guide channel 141.

In a case that the aerosol generating device 1000 (shown in FIG. 1) is inhaled, the aerosol generating substrate in the liquid storage reservoir 31 (the liquid storage reservoir 31 communicated with the first liquid guide channel 141) can be consumed, thus generating a negative pressure inside the liquid storage reservoir 31. In this case, if the liquid storage reservoir 31 is not communicated with the external air, it is hard for the aerosol generating substrate in the liquid storage reservoir 31 to quickly enter the first liquid guide channel 141, or even the aerosol generating substrate cannot enter the first liquid guide channel 141, thus affecting the aerosol generation amount and deteriorating the inhalation mouth feel of a user. In this application, the first ventilation channel 171 is communicated with both the external air and the first liquid guide channel 141, so that the external air flows into the liquid storage reservoir 31 through the first liquid guide channel 141. Therefore, in a case that the aerosol generating device 1000 is inhaled, the first ventilation channel 171 can adjust the air pressure of the liquid storage reservoir 31, to ensure that the aerosol generating substrate in the liquid storage reservoir 31 can flow into the first liquid guide channel 141, thereby ensuring the aerosol generation amount and enhancing the inhalation mouth feel of a user.

Referring to FIGS. 2, 3, 6, and 8, in some embodiments, the second liquid guide member 18 is provided with a second ventilation channel 185. The second ventilation channel 185 is communicated with both the external air and the second liquid guide channel 143, to allow the external air to flow into the liquid storage reservoir 31 through the second liquid guide channel 143. Specifically, in some embodiments, the second ventilation channel 185 may be disposed on the outer side of the peripheral wall of the second liquid guide member 18. Furthermore, one end of the second ventilation channel 185 is communicated with the air inlet hole 15 (the air inlet hole 15 communicated with the second atomization channel 133), and the other end of the second ventilation channel 185 is communicated with the second liquid guide channel 143.

In a case that the aerosol generating device 1000 (shown in FIG. 1) is inhaled, the aerosol generating substrate in the liquid storage reservoir 31 (the liquid storage reservoir 31 communicated with the second liquid guide channel 143) can be consumed, thus generating a negative pressure inside the liquid storage reservoir 31. In this case, if the liquid storage reservoir 31 is not communicated with the external air, it is hard for the aerosol generating substrate in the liquid storage reservoir 31 to quickly enter the second liquid guide channel 143, or even the aerosol generating substrate cannot enter the first liquid guide channel 143, thus affecting the aerosol generation amount and deteriorating the inhalation mouth feel of a user. In this application, the second ventilation channel 185 is communicated with both the external air and the second liquid guide channel 143, so that the external air flows into the liquid storage reservoir 31 through the second liquid guide channel 143. Therefore, in a case that the aerosol generating device 1000 is inhaled, the second ventilation channel 185 can adjust the air pressure of the liquid storage reservoir 31, to ensure that the aerosol generating substrate in the liquid storage reservoir 31 can flow into the second liquid guide channel 143, thereby ensuring the aerosol generation amount and enhancing the inhalation mouth feel of a user.

Referring to FIGS. 2-4, in some embodiments, the atomization base 10 further includes a top cover 19. The top cover 19 is connected to the base 16, the first liquid guide member 17, and/or the second liquid guide member 18. The top cover 19 is provided with a first via hole 191 and a second via hole 193. The first via hole 191 is configured to communicate the first liquid guide channel 141 with one liquid storage reservoir 31, and the second via hole 193 is configured to communicate the second liquid guide channel 143 with the other liquid storage reservoir 31.

Specifically, referring to FIG. 1, in some embodiments, the first liquid guide member 17 and the second liquid guide member 18 are disposed between the top cover 19 and the base 16 in the direction from the first side 11 to the second side 12. For example, the top cover 19 may be connected to the base 16, the first liquid guide member 17, and the second liquid guide member 18, and the second liquid guide member 18 may be connected to the base 16, so that the top cover 19, the base 16, the first liquid guide member 17, and the second liquid guide member 18 jointly form an integrated structure (i.e. the atomization base 10). In a case that the aerosol generating device 1000 is inhaled, the aerosol generating substrate in one liquid storage reservoir 31 can flow into the first liquid guide channel 141 through the first via hole 191. The aerosol generating substrate in the other liquid storage reservoir 31 can flow into the second liquid guide channel 143 through the second via hole 193, so that the atomizer 100 can generate aerosols for inhalation by a user.

Further, in some embodiments, a fourth sealing element 67 is disposed between the top cover 19 and the first liquid guide member 17. The fourth sealing element 67 surrounds the first via hole 191. The fourth sealing element 67 is configured to seal a gap between the top cover 19 and the first liquid guide member 17. The arrangement of the fourth sealing element 67 can prevent the aerosol generating substrate from leaking through the gap between the top cover 19 and the first liquid guide member 17. In one aspect, the waste of the aerosol generating substrate can be reduced. In another aspect, this can reduce the possibility of damage to an electrical control assembly 300 due to the contact between the aerosol generating substrate and the electrical control assembly 300 and enhance the stability and reliability of operation of the aerosol generating device 1000. It should be noted that in some embodiments, the fourth sealing element 67 may be made of a material such as rubber, silicone, plastic, or synthetic fibers.

In some embodiments, a fifth sealing element 69 is disposed between the top cover 19 and the second liquid guide member 18. The fifth sealing element 69 surrounds the second via hole 193. The fifth sealing element 69 is configured to seal a gap between the top cover 19 and the second liquid guide member 18.

The arrangement of the fifth sealing element 69 can prevent the aerosol generating substrate from leaking through the gap between the top cover 19 and the second liquid guide member 18. In one aspect, the waste of the aerosol generating substrate can be reduced. In another aspect, this can reduce the possibility of damage to an electrical control assembly 300 due to the contact between the aerosol generating substrate and the electrical control assembly 300 and enhance the stability and reliability of operation of the aerosol generating device 1000. It should be noted that in some embodiments, the fifth sealing element 69 may be made of a material such as rubber, silicone, plastic, or synthetic fibers.

In some embodiments of this application, the fourth sealing element 67 and the fifth sealing element 69 may be of integrated structures. That is, the fourth sealing element 67 and the fifth sealing element 69 are of an integrated structure made by integrated molding. Thus, this can reduce the number of components of the atomizer 100, facilitate the mounting of the fourth sealing element 67 and the fifth sealing element 69, and help enhance the assembling efficiency of the atomizer 100.

Referring to FIGS. 1-4, in some embodiments, the atomizer 100 further includes a barrier 70. The barrier 70 covers an opening. The atomization base 10 is mounted on the side of the barrier 70 facing away from the liquid storage reservoir 31 and is connected to the liquid storage member 30. The barrier 70 is provided with at least two through holes 71. The at least two through holes 71 are respectively correspondingly communicated with the two liquid storage reservoirs 31. The through holes 71 are configured to allow the aerosol generating substrates in the corresponding liquid storage reservoirs 31 to flow into the atomization base 10. In one aspect, the arrangement of the barrier 70 can seal the gap between the liquid storage member 30 and the atomization base 10 and prevent the aerosol generating substrates in the liquid storage reservoirs 31 from leaking through the gap between the liquid storage member 30 and the atomization base 10, thereby not only reducing the waste of the aerosol generating substrates, but also reducing the possibility of damage to an electrical control assembly 300 due to the contact between the aerosol generating substrates and the electrical control assembly 300. In another aspect, the barrier can play a role in isolating the two liquid storage reservoirs 31, to ensure that the two liquid storage reservoirs 31 are not communicated with each other.

Specifically, in some embodiments, in a case that the aerosol generating device 1000 is inhaled, the aerosol generating substrate in one liquid storage reservoir 31 can sequentially flow into the first liquid guide channel 141 through the through hole 71 and the first via hole 191. The aerosol generating substrate in the other liquid storage reservoir 31 can sequentially flow into the second liquid guide channel 143 through the through hole 71 and the second via hole 193, so that the atomizer 100 can generate aerosols for inhalation by a user. It should be noted that in some embodiments, the barrier 70 may be made of a material such as rubber, silicone, plastic, or synthetic fibers. The rubber material includes but is not limited to natural rubber, nitrile rubber, fluororubber, polyurethane rubber, ethylene-propylene-diene monomer, silicone rubber, or the like.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An atomizer, comprising:
an atomization base comprising a first side and a second side that face away from each other;
a liquid storage member connected to the atomization base, the liquid storage member having at least one liquid storage reservoir configured to store an aerosol generating substrate, the at least one liquid storage reservoir being located on the first side; and
a heating assembly disposed on the atomization base, the heating assembly comprising two heating elements configured to heat the aerosol generating substrate so as to generate aerosols, each heating element of the two heating elements comprising a heating surface,
wherein a heating surface of one heating element of the two heating elements is parallel to a direction from the first side to the second side, and
wherein a heating surface of another heating element of the two heating elements is perpendicular to the direction from the first side to the second side.

2. The atomizer of claim 1, wherein the at least one liquid storage reservoir comprises two liquid storage reservoirs spaced apart from each other, and
wherein the two heating elements are respectively configured to heat the aerosol generating substrates in the two liquid storage reservoirs.

3. The atomizer of claim 1, wherein the atomization base is provided with two atomization channels and at least one liquid guide channel;
wherein the atomization base is provided with two air inlet holes, and
wherein the two air inlet holes are respectively communicated with the two atomization channels and are configured to allow external air to flow into corresponding atomization channels.

4. The atomizer of claim 3, wherein the at least one liquid guide channel comprises two liquid guide channels are provided,
wherein the two atomization channels comprise a first atomization channel and a second atomization channel,
wherein the two liquid guide channels comprise a first liquid guide channel and a second liquid guide channel,
wherein the two heating elements comprise a first heating element and a second heating element,
wherein the first heating element comprises a first heating surface,
wherein the first heating surface is parallel to the direction from the first side to the second side and is opposite the first atomization channel,
wherein the first heating element is disposed at the first liquid guide channel,
wherein the second heating element comprises a second heating surface,
wherein the second heating surface is perpendicular to the direction from the first side to the second side and is opposite the second atomization channel, and
wherein the second heating element is disposed at the second liquid guide channel.

5. The atomizer of claim 4, wherein the first heating element comprises a first liquid guide surface facing away from the first heating surface,
wherein an abutting surface is formed on an inner wall of the first liquid guide channel,
wherein the abutting surface abuts against the first liquid guide surface,
wherein a first sealing element is disposed between the abutting surface and the first liquid guide surface, and
wherein the first sealing element is configured to seal a gap between the abutting surface and the first liquid guide surface.

6. The atomizer of claim 4, wherein the second heating element comprises a second liquid guide surface and a peripheral side surface,
wherein the second liquid guide surface faces away from the second heating surface,
wherein the peripheral side surface is connected between the second heating surface and the second liquid guide surface,
wherein a second sealing element is disposed between the peripheral side surface and an inner wall of the second liquid guide channel, and
wherein the second sealing element is configured to seal a gap between the peripheral side surface and the inner wall of the second liquid guide channel.

7. The atomizer of claim 4, wherein the atomization base comprises:
a base connected to the liquid storage member;
a first liquid guide member disposed on a side of the base facing the at least one liquid storage reservoir and provided with the first liquid guide channel; and
a second liquid guide member disposed on a side of the base facing the at least one liquid storage reservoir and provided with the second liquid guide channel and a first sub-channel,
wherein the second liquid guide member forms the first atomization channel together with the first liquid guide member and forms a second sub-channel together with the base, and
wherein the first sub-channel and the second sub-channel are communicated with each other to jointly form the second atomization channel.

8. The atomizer of claim 7, wherein the second liquid guide member comprises:
a first sub-member arranged on the base, the first sub-member being provided with a first sub-path and a part of the first sub-channel, and forming the second sub-channel together with the base; and
a second sub-member connected to a side of the first sub-member facing away from the base, the second sub-member being provided with a second sub-path and another part of the first sub-channel,
wherein the first sub-path and the second sub-path are communicated with each other to jointly form the second liquid guide channel.

9. The atomizer of claim 8, wherein a third sealing element is disposed between the first sub-member and the second sub-member, and
wherein the third sealing element is configured to seal a gap between the first sub-member and the second sub-member.

10. An aerosol generating device, comprising:
an electrical control assembly; and
an atomizer, the atomizer comprising:
an atomization base comprising a first side and a second side that face away from each other;
a liquid storage member connected to the atomization base, the liquid storage member being provided with at least one liquid storage reservoir configure to store an aerosol generating substrate, the at least one liquid storage reservoir being located on the first side; and
a heating assembly disposed on the atomization base, the heating assembly comprising two heating elements configured to heat the aerosol generating substrate so as to generate aerosols, each heating element of the two heating elements comprising a heating surface,
wherein the heating surface of one heating element of the two heating elements is parallel to a direction from the first side to the second side,
wherein the heating surface of another heating element of the two heating elements is perpendicular to the direction from the first side to the second side, and
wherein the atomizer is electrically connected to the electrical control assembly.

11. The atomizer of claim 10, wherein the at least one liquid storage reservoir comprises two liquid storage reservoirs spaced apart from each other, and
wherein the two heating elements are respectively configured to heat the aerosol generating substrates in the two liquid storage reservoirs.

12. The atomizer of claim 10, wherein the atomization base is provided with two atomization channels and at least one liquid guide channel,
wherein the atomization base is provided with two air inlet holes, and
wherein the two air inlet holes are respectively communicated with the two atomization channels and are configured to allow external air to flow into corresponding atomization channels.

13. The atomizer of claim 12, wherein the at least one liquid guide channel comprises two liquid guide channels,
wherein the two atomization channels comprise a first atomization channel and a second atomization channel,
wherein the two liquid guide channels comprise a first liquid guide channel and a second liquid guide channel,
wherein the two heating elements comprise a first heating element and a second heating element,
wherein the first heating element comprises a first heating surface,
wherein the first heating surface is parallel to the direction from the first side to the second side and is opposite the first atomization channel,
wherein the first heating element is disposed at the first liquid guide channel,
wherein the second heating element comprises a second heating surface,
wherein the second heating surface is perpendicular to the direction from the first side to the second side and is opposite the second atomization channel, and
wherein the second heating element is disposed at the second liquid guide channel.

14. The atomizer of claim 13, wherein the first heating element comprises a first liquid guide surface facing away from the first heating surface,
wherein an abutting surface is formed on an inner wall of the first liquid guide channel,
wherein the abutting surface abuts against the first liquid guide surface,
wherein a first sealing element is disposed between the abutting surface and the first liquid guide surface, and
wherein the first sealing element is configured to seal a gap between the abutting surface and the first liquid guide surface.

15. The atomizer of claim 13, wherein the second heating element comprises a second liquid guide surface and a peripheral side surface,
wherein the second liquid guide surface faces away from the second heating surface,
wherein the peripheral side surface is connected between the second heating surface and the second liquid guide surface,
wherein a second sealing element is disposed between the peripheral side surface and an inner wall of the second liquid guide channel, and
wherein the second sealing element is configured to seal a gap between the peripheral side surface and the inner wall of the second liquid guide channel.

16. The atomizer of claim 13, wherein the atomization base comprises:
a base connected to the liquid storage member;
a first liquid guide member disposed on a side of the base facing the at least one liquid storage reservoir and provided with the first liquid guide channel; and
a second liquid guide member disposed on a side of the base facing the at least one liquid storage reservoir and provided with the second liquid guide channel and a first sub-channel,
wherein the second liquid guide member forms the first atomization channel together with the first liquid guide member and forms a second sub-channel together with the base, and
wherein the first sub-channel and the second sub-channel are communicated with each other to jointly form the second atomization channel.

17. The atomizer of claim 16, wherein the second liquid guide member comprises:
a first sub-member arranged on the base, the first sub-member being provided with a first sub-path and a part of the first sub-channel, and forming the second sub-channel together with the base; and
a second sub-member connected to a side of the first sub-member facing away from the base,
wherein the second sub-member is provided with a second sub-path and another part of the first sub-channel, and
wherein the first sub-path and the second sub-path are communicated with each other to jointly form the second liquid guide channel.

18. The atomizer of claim 17, wherein a third sealing element is disposed between the first sub-member and the second sub-member, and
wherein the third sealing element is configured to seal a gap between the first sub-member and the second sub-member.
